(19) United States
(12) Patent Application Publication
(10) Pub. No.: US 2011/0149953 A1
(43) Pub. Date: Jun. 23, 2011

(54) Tracking results of a v2 query in voice over internet (VoIP) emergency call systems

(76) Inventors: William Helgeson, Kirkland, WA (US); Gerhard Geldenbott, Seattle, WA (US)

(21) Appl. No.: 12/926,997

(22) Filed: Dec. 22, 2010

Related U.S. Application Data
(60) Provisional application No. 61/282,163, filed on Dec. 23, 2009.

(51) Int. Cl. H04L 12/66

(52) U.S. Cl. 370/352

(57) ABSTRACT

A simplified method of encoding information needed to set the NENA 08-001 v2 Result code based on two essential factors that are stored in a data store at runtime. An ESRResponse header is built with two fields created as simple enumerated types: LocationSrc and RoutedOnAlgo. For each emergency call there is one entry in this data store. The first field of the ESRResponse header comprises one of five possible unique values, as does the second field.

This application claims priority from U.S. Provisional No. 61/282,163, entitled “Tracking Results of a v2 Query in Voice Over Internet (VoIP) Emergency Call Systems,” filed Dec. 23, 2009, the entirety of which is expressly incorporated herein by reference.

### BACKGROUND OF THE INVENTION

1. Field of the Invention

This invention relates to the processing of call routing requests over the v2 interface according to NENA i2 standards for VoIP emergency calls.

2. Background of Related Art

The present invention improves upon procedures described in NENA Interim VoIP Architecture for Enhanced 9-1-1 Services (i2), NENA 08-001 V2 Specification.”

Section 6.3 of the NENA Interim VoIP Architecture for Enhanced 9-1-1 Services (i2), explains in pertinent part as follows:

The v2-Call Server/Routing Proxy/Redirect Server (“CS/RP/RS”) to VPC interface provides a means for the CS/RP/RS to request emergency services routing information from a Voice Over Internet Protocol (VoIP) positioning center (VPC), and to inform the VPC, at call termination, when a routing/query key is no longer required. This v2 interface utilizes four messages, and is XML-based.

The v2 interfaces is based on HTTP over TLS protocol using web services as a transport mechanism, to provide strong security mechanisms, making it readily able to traverse enterprise and commercial firewalls.

Two sets of Request/Response messages are defined in the v2 interface (for a total of 4 messages). The first message set requests and receives routing instructions. The second message set indicates that an emergency call has concluded.

An esrRequest message is sent from a query node (CS/RP/RS) to the VPC to request routing information and a query key. Valid parameters for the esrRequest are included in the following table:

TABLE 6-1
esrRequest Parameters

| Parameter | Condition | Description |
|---|---|---|
| source | Mandatory | The identifier of the node requesting |
| | | routing information directly from the |
| | | VPC. |
| Vsp | Conditional | The identifier of the caller's voice |
| | | service provider. |
| callId | Mandatory | Any identifier that can uniquely |
| | | identify the call globally. |
| datetimestamp | Optional | Date Time Stamp indicating UTC |
| | | date and time that the message was |
| | | sent |
| callback | Conditional | E.164 number that can be dialed by |
| | | a PSAP operator to reach the call |
| Lie | Mandatory | The Location Information Element |
| callOrigin | Optional | An ID inserted by the originating |
| | | network that allows LIS to validate if |
| | | the call is from the originating |
| | | network. |
| Vpc | Optional | The identifier of the destination VPC. |
| customer | Conditional | The subscriber/account name |
| | | associated with the callback number. |

A <source> element identifies the node directly requesting emergency call routing from the VPC over the v2 interface. It includes the source node <hostId>, a NENA administered identifier (nenaId) a 24×7 contact number (contact), and an optional uri URI (certUri) providing a link to the provider's VESA issued certificate. The <source> must be a trusted entity of the VPC.

The <organizationName> is a free form text field into which the node owner may place their company name or other label. This field is optional.

The <hostId> identifies the fully qualified domain name or IP address of the directly requesting node. This field is mandatory.

The <nenaId> is the NENA administered company identifier ((NENA Company ID) of the node requesting routing information over the V2 interface. This field is optional.

The <contact> is a telephone number by which the directly requesting node operator can be reached 24 hours a day, 7 days a week. This field is mandatory.

The <certUri> provides a means of directly obtaining the VESA issued certificate for the requesting node. This field is optional.

The <vsp> element identifies the Voice Service Provider for the call. This element is used to identify the original VoIP service provider, in cases where the original VSP is not the same entity as the one requesting routing information over the v2 interface. In cases where the VoIP service provider and the entity requesting routing information are not the same, the <source> element is used to identify the entity requesting routing information over the v2 interface and the <vsp> element is used to identify the voice service provider.

The <hostId> and <contact> elements must be provided. The <organizationName>, <nenaId> and <certUri> fields are optional.

The <callId> element is an identifier that can be used to uniquely identify the call globally. If a callId is received in SIP signaling, the Call Server shall use the received callId as the callId over the v2 interface. If a callId is not received in incoming signaling, the call server/proxy shall follow the recommended procedures as specified in RFC3261 for UA Call-ID generation.

The <callback> number is a tel-uri of the format “tel: 1-212-555-8215”. This identifies the E.164 number that can be dialed to reach the caller. This is the number that will be included in the callback number field in the esposreq response message to the ALI.

The <lie> is the Location Information Element that contains location information that is used to determine the routing and query keys to be used for the call. This parameter is mandatory, and if not provided, the VPC must provide default routing or an error to the requesting node. If the <lie> is present in the esrRequest, then it may contain a LocationKey, a PIDF-LO (geodetic and or Civic), or both. The exact mechanism used to determine the routing and query keys is dependent on the contents of the <lie>.

The <callOrigin> parameter is used by the VPC when it sends a LocationKey to the LIS over the v3 interface. The LIS is able to use this parameter to determine if the LocationKey received belongs to the originating network. Use of this parameter is LIS implementation-specific and is subject to local access network policy.

<callOrigin>accessNetwork.com</callOrigin>

The <datetimestamp> is the date time stamp in UTC time using ISO 8601 [44] format indicating the time that the message was sent from the requesting mode. This field is optional, but if not included, then the VPC must maintain an accurate date and time stamp in any call event records so that an audit trail is readily accessible.

<datetimestamp>2004-12-12T21:28:43z<datetimestamp>

The <vpc> element identifies the VPC from which routing information is being requested.

The coding of the VPC element is the same as the coding for the source element.

The <customer> is an alphanumeric field that identifies the subscriber/account owner name associated with the callback number in subscription data. The customer name will be included in the <NAM> field of the Location Description parameter in the esposreq response message to the ALI.

<customer>Turin Turumbar</customer>

When the LIE contains a PIDF-LO, the VPC will perform a lookup in the ERDB, to obtain the ERT consisting of a Selective Routing Identifier (i.e., CLLI code), a routing ESN, and an NPA, as well as a contingency routing number (CRN) for the PSAP. Using the Selective Routing Identifier, routing ESN, and NPA, the VPC can identify and allocate an ESQK. The ESQK, CRN, and either the ERT or ESGWRI are subsequently returned to the Call Server/Proxy in an esrResponse message, with the CRN being carried to the Call Server as an LRO.

The LocationKey provides information to the VPC on where to get the location of the caller. The LocationKey may explicitly indicate a client-id and a LIS, say in the form of a URI, or it may be a different form of identifier, such as callback number, that the VPC can use internally to determine a LIS and subsequently request a location object. Having determined the LIS from the LocationKey, the VPC then passes the LIE to the LIS and receives a LIE back, this time containing the original LocationKey and a PIDF-LO. The VPC is then able to route based on the PIDF-LO.

The esrResponse message is sent by the VPC to a routing entity (Call Server/Routing Proxy/Redirect Server) in response to an esrRequest message. Valid parameters for the esrResponse message are contained in the following table.

TABLE 6-2
esrResponse Parameters

| Parameter | Condition | Description |
|---|---|---|
| vpc | Mandatory | The identifier of the responding |
| | | VPC |
| callId | Mandatory | An identifier that uniquely identifies |
| | | the call at the Call Server. |
| esgwri | Conditional | If determined by the VPC, this field |
| | | will contain the Routing Key that |
| | | allows routing of the call to the |
| | | Selective Router servicing the local |
| | | area in which the call was made. |
| ert | Conditional | The Emergency Route Tuple |
| | | comprised of the following tags |
| | | used by the receiving node to select |
| | | the appropriate ESGWRI. |
| selectiveRoutingID | Conditional | The Common Language Location |
| | | Indicator (CLLI) code associated |
| | | with the Selective Router to which |
| | | the emergency call is to be directed. |
| routingESN | Conditional | The Emergency Services Number |
| | | associated with a particular ESZ |
| | | that represents a unique |
| | | combination of Police, Fire and |
| | | EMS emergency responders. |
| npa | Conditional | The Numbering Plan Area (NPA) |
| | | associated with the outgoing route |
| | | to the Selective Router that is |
| | | appropriate for caller's location. |
| esqk | Conditional | The Query Key allocated by the |
| | | VPC to uniquely identify the call |
| | | within ESZ. |
| lro | Conditional | The last routing option. This routing |
| | | option should only be used by the |
| | | call server or proxy as a last resort. |
| | | The actual meaning of the LRO is |
| | | different depending on what other |
| | | information is returned in response |
| | | to the query. |
| Result | Mandatory | Code indicating the reason for |
| | | success or failure to determine an |
| | | ERT and ESQK. |
| datetimestamp | Optional | Date Time Stamp indicates UTC |
| | | date and time that the message |
| | | was sent |
| destination | Optional | The identifer of the routing node |
| | | immediately adjacent to the VPC. |

The <vpc> element identifies the VPC.

The <hosted>, <nenaId>, and <contact> fields are mandatory while the other fields of the <vpc> element are optional.

The <destination> element identifies the node that directly requested emergency call routing information from the VPC. It includes the source node (hostId), a NENA administered Company ID identifier (nenaId), a 24×7 contact number (contact), and optional parameters for the oganization's name and URI (certUri) for the operator's VESA issued certificate. The <destination> must be a trusted entity of the VPC.

The <organizationName> is a free form text field into which the node owner may place their company name or other label. This field is optional.

The <hostId> identifies the fully qualified domain name or IP address of the directly requesting node. This field is mandatory.

The <nenaId> is the NENA administered company identifier (NENA Company ID). This field is mandatory.

The <callId> is an identifier that uniquely identifies the call at the requesting node.

<callId>767673678674835784587</callId>

The <esgwri> is the translation of the ERT with ESGW-specific information provided by either the VSP or ESGW operator directly. An <esgwri> may be provided if the VPC performs the ERT-to-ESGWRI translation and a corresponding <esqk> is provided. The ESGwri format is as follows:

sip: 1 numberstring@esgwprovider.domain;user+phone

where the “numberstring” is 10 numeric characters (e.g., nnnnnnnnnn)

The <selectiveRoutingID> contains the CLLI code of the selective router to which the call is being routed. The CLLI code is an 11 character alphanumeric field of the form AAAABBCCDDD, where AAAA represents the city/county, BB represents the state, CC represents the building or location, and DDD represents the network.

The Selective Routing Identifier will be included in the response message if the VPC is not responsible for performing ERT-to-ESGWRI translation. The <selectiveRoutingID> must only be provided if a <routingESN>, <npa>, and <esqk> are also provided, and must not be provided if an <esgwri> is provided.

The <routingESN> is a 3- to 5 digit field that uniquely identifies the ESZ in the context of an SR, and the associated Police, Fire, and EMS emergency responders associated with teh ESZ. The <routingESN> must only be provided if a <selectiveRoutingID>, <npa>, and <esqk> are also provided, and must not be provided if an <esgwri> is provided.

The <npa> is a 3 digit field that identifies an NPA associated with an outgoing trunk group to the appropriate SR associated with the caller's location. The <npa> must only be provided if a <selectiveRoutingID>, <routingESN>, and <esqk> are also provided, and must not be provided if an <esgwri> is provided.

The <esqk> element contains the ESQK allocated by the VPC. This key identifies an ESN for a specific PSAP, as well as the call instance at the VPC. A valid value must be returned in this field for the call to be successfully routed to the appropriate PSAP, and for location information to be supplied from the VPC to the PSAP. AN <esqk> must only be provided if a corresponding <esgwri> or <ert> is also provided. The <esqk> is expected to be a 10-digit North American Numbering Plan Number.

<esqk>npanxxnnnn</esqk>

The <lro> element contains the last routing option and provides the routing node with a “last chance” destination for the call. The LRO may contain the Contingency Routing Number (CRN), which is a 24×7 PSAP emergency number, or it may contain a routing number associated with a national or default call center. The service type will depend on the condition that resulted in the providing of the LRO. Ultimately the usage of LRO routing data for call delivery will depend on decisions made internally to the routing node. There may be occasions when the VPC only returns an LRO. Examples of scenarios in which this may be the case include invalid or unavailable location information, VPC resource limitations, or the invoking of local PSAP routing policies. When primary routing options fail, and no LRO is provided, the routing node is required to provide specific default handling, which may include dropping the call. The <lro> shall be expressed as a URI.

<lro>tel: 1-npa-nxx-nnnn</lor>

The <result> element indicates to the routing node whether or not the VPC was able to provide routing information and the means by which the routing data was determined, or if no routing information could be provided, the source of the problem. This element therefore provides a means by which the VSP can monitor the quality of the routing information provided by a VPC operator. A complete list of valid <result> codes is detailed in Table 6-3. The values of the code are expected to be sent in this element.

<result>200 SuccessGeodetic</result>

The <datetimestamp> is the date time stamp in UTC time using ISO 8601 [44] indicating the time that the message was sent from the VPC. This field is optional, but if not included, then the routing node must maintain an accurate date and time stamp in any call event records so that an audit trail is readily accessible.

<datetimestamp>2004-12-12T21:28:43z</datetimestamp>

TABLE 6-3
V2 esrResponse Result Codes
(Source: NENA Interim VoIP Architecture for
Enhanced 9-1-1 Services (i2), NENA 08-001)

| Value | Name | Description |
|---|---|---|
| 200 | SuccessGeodetic | VPS has successfully determined the |
| | | routing information based on geodetic |
| | | information contained in the initial |
| | | esrRequest |
| 201 | SuccessLISGeodetic | VPC has successfully determined the |
| | | routing information based on geodetic |
| | | information obtained from the LIS. |
| 202 | SuccessCivic | VPC has successfully determined the |
| | | routing information based on civic |
| | | information contained in the initial |
| | | esrRequest. |
| 203 | SuccessLISCivic | VPC has successfully determined |
| | | routing information based on civic |
| | | information obtained from the LIS |
| 400 | LROBadLocation | No routing information can be |
| | | determined from the location provided |
| | | in the LIE. This may be because the |
| | | LIE is malformed, or because the |
| | | location does not map to a |
| | | provisioned PSAP boundary. LRO is |
| | | provided, but this is really default |
| | | routing. |
| 401 | LRONoLIS | The VPC is unable to determine the |
| | | LIS from which to get the location. |
| | | An LRO is returned. |
| 402 | LRONoLocation | The VPC was unable to get a location |
| | | for the client from the LIS. An LRO is |
| | | returned. |
| 403 | LROBadMessage | The esrRequest received by the VPC |
| | | could not be parsed or was |
| | | malformed. An LRO is provided. |
| 404 | LRONoAuthorization | The requesting node's esrRequest |
| | | message failed authorization at the |
| | | VPC. An LRO is provided. |
| 405 | ErrorBadLocation | VPC was unable to get routing |
| | | information based on the sourced |
| | | location. VPC is unable to provide an |
| | | LRO for routing. |
| 406 | ErrorNoLIS | VPC was unable to determine the LIS |
| | | based on a provided location key. |
| | | VPC is unable to provide an LRO for |
| | | routing. |
| 407 | ErrorNoLocation | The VPC is unable to get a location |
| | | from the LIS for the location key |
| | | provided. VPC is unable to provide |
| | | an LRO for routing. |
| 408 | ErrorBadMessage | The esrRequest received by the VPC |
| | | could not be parsed or was |
| | | malformed. VPC is unable to provide |
| | | an LRO for routing. |
| 409 | Error Authorization | The requesting node's esrRequest |
| | | message failed authorization at the |
| | | VPC. VPC is unable to provide an |
| | | LRO for routing. |
| 500 | LRONoResource | VPC was unable to allocate an ESQK |
| | | (or default ESQK) due to failure, and |
| | | an LRO is provided to enable default |
| | | routing. |
| 501 | LROGeneralError | A general error is encountered and |
| | | the VPC provides a LRO to enable |
| | | default routing. |
| 502 | ErrorNoResource | The VPC is unable to allocate an |
| | | ESQK (or default ESQK) due to |
| | | failure, and no CRN was provided |
| | | from the ERDB. VPC is unable to |
| | | provide an LRO for routing. |
| 503 | ErrorGeneral | Any error cause that is not listed |
| | | above. VPC is unable to provide an |
| | | LRO for routing. |

FIG. 2 depicts a conventional example esrResponse message showing a successful response (result=200).

In particular, the example message of FIG. 2 contains valid <esqk> and <lro> values, along with a valid <ert> consisting of a <selectiveRoutingID>, <routingESN>, and <npa>. Note that this message could contain a valid <esgwri> instead of the <ert> if the VPC performs the ERT-to-ESGWRI translation.

The emergency services call termination (ESCT) message is sent from the routing node to the VPC at the conclusion of the emergency call. The intent of this message is to return the <esqk> associated with the call back to the pool of available query keys for use by the VPC, and to inform the VPC as to which ESGW was used to direct the call to the Selective Router. The valid parameters for the ESCT message are included in the following table.

TABLE 6-4
ESCT Parameters

| Parameter | Condition | Description |
|---|---|---|
| source | Mandatory | The identifier of the routing node directly |
| | | adjacent to the VPC. |
| esqk | Conditional | The ESQK to return to the VPC pool. |
| esgw | Conditional | The identifier of the ESGW used to direct |
| | | the call to the selective router. |
| datatimestamp | Optional | Date Time Stamp indicating UTC date |
| | | and time that the message was sent. |
| callId | Mandatory | The identifier that uniquely identified the |
| | | call at the Call Server. |
| vpc | Optional | The identifier of the VPC. |

The <source> element identifies the node directly requesting emergency call routing from the VPC. It includes the source node (hostId), a 24×7 contact number (contact), as well as an optional NENA administered company identifier (nenaId), and an optional uri (certUri) that provides a link to the provider's VESA issued certificate. The <source> must be a trusted entity of the VPC.

The value of <hostId> element within <source> element must be identical within any set of associated esrRequest and ESCT messages.

An <organizationName> element stores free form text field into which the node owner may place their company name or other label. This field is optional.

A <hostId> field identifies the fully qualified domain name or IP address of the directly requesting node. This field is mandatory.

A <nenaId> element stores the NENA administered company identifier (NENA Company ID). This field is optional.

A <contact> element stores a telephone number by which the directly requesting node operator can be reached 24 hours a day, 7 days a week. This element is mandatory.

A <certUri> element provides a means of directly obtaining the VESA issued certificate for the requesting node. This element is optional.

A <vpc> element identifies the VPC.

The <hostId> and the <contact> must be provided. The <nenaId>, <organizationName> and <certUri> fields are optional.

The <esqk> element stores the ESQK that was allocated by the VPC for the call. This is the ESQK that can now be returned to the pool of ESQKs available for use by the VPC.

<esqk>npa-nxx-nnnn</esqk>

The <esgw> element stores the identifier for the ESGW that was used to direct the call to the selective router. If an LRO was used to route the call, then this element must not be present in the ESCT message. The <esgw> is expected to be in the form of an IP address or a fully qualified domain name.

<esgw>http://esgwprovider1.example.com</esgw>

The <callId> element stores the identifier that uniquely identifies the call at the querying node.

<callId>sips:123456789456123@ca34.example.com</callId>

Any <callId> values must be identical within any set of associated esrRequest and ESCT messages.

The <datetimestamp> element stores the date time stamp in UTC time using ISO 8601 [44] format indicating the time that the message was sent from the routing node. This field is optional, but if not included, then the VPC must maintain an accurate date and time stamp in any call event records so that an audit trail is readily accessible.

<datetimestamp>2004-12-12T21:28:43Z</datetimestamp>

An esctAck message is sent from the VPC to the routing entity (CS/RP/RS) in response to an ESCT message. If the Call Server does not receive an esctAck message after a specified time period, the Call Server will log this event. The length of specified time period is an implementation detail. The valid parameters for the esctAck message are contained in Table 6-5.

TABLE 6-5
v2 esctAck Message Parameters

| Parameter | Condition | Description |
|---|---|---|
| callId | Mandatory | Identifies the call at the routing element. |
| vpc | Mandatory | The identifier of the VPC. |
| Datetimestamp | Optional | Date & Time Stamp indicating UTC date |
| | | and time that the message was sent. |

The <callId> element stores the identifier that uniquely identifies the call at the routing element.

<callId>sips:123456789456123@cs34.example.com</callId>

The <vpc> element identifies the VPC.

The <hostId> and <contact> must be provided. The <nenaId>, <organizationName> and <certUri> fields are optional.

The <datetimestamp> parameter stores the date and time stamp in UTC time using ISO 8601 [44] format indicating when the message was sent from the VPC. This field is optional, but if not included, then the routing node must maintain an accurate date and time stamp in any call event records so that an audit trail is readily accessible.

<datetimestamp.2004-12-12T21:28:43Z</datetimestamp>

FIG. 3 shows a conventional call flow where a valid PIDF-LO document containing a geodetic and/or civic location is provided by the LIS. In FIG. 3, v2 messages are identified in bold.

As shown in step 1 of FIG. 3, the LIS provides a PIDF-LO containing geodetic and/or civic information to the UA over v0.

In step 2 of FIG. 3, the US initiates an emergency call to the CS over v1 and includes the PIDF-LO in the call initiation message.

In step 3 the CS determines the provisioned callback number and subscriber name associated with the UA, and constructs an esrRequest message that includes a Call-ID, callback number, subscriber name, and LIE containing the PIDF-LO. The CS sends the esrRequest message to the VPC over v2.

In step 4, the VPC receives the esrRequest from the CS and authenticates the CS. The VPC uses the location contained in the PIDF-LO to obtain an ERT consisting of a Selective Routing Identifier, routing ESN, and NPA, and a CRN from the ERDB (not shown). The VPC allocates an ESQK based on the ERT. The VPC constructs an esrResponse message containing the ESQK, LRO, and either the ESGWRI or the ERT, and returns this to the CS over v2.

In step 5, the CS uses the ESGWRI, if received in the routing response, to determine the correct ESGW, or the CS determines the ESGW and appropriate ESGWRI value based on the ERT received in the routing response message. The Call Server subsequently routes the call to the ESGW over v4, and includes the ESGWRI, ESQK and callback number in outgoing signaling.

In step 6, the CS detects that the call has concluded, and that the ESQK is no longer required.

In step 7, the CS sends an ESCT message containing the ESQK, ESGW identifier and call ID to the VPC.

In step 8, the VPC accepts the ESCT message, authenticates the Call Server, returns the ESQK to the pool of available keys, and notes the ESGW in its call event records. The VPC sends an esctAck message to the Call Server.

FIG. 4 describes a conventional call flow where a Location Key is provided by the LIS, noting that the Location Key cannot be genuinely used for routing and must be de-referenced at the LIS first. In FIG. 4, v2 messages are identified in bold.

In step 1 of FIG. 4, the LIS provides a LocationKey to the UA over v0. The LocationKey may explicitly identify a client and LIS, or it may contain a value that implies these identities to the VPC. Regardless of the actual implementation, the LocationKey provides sufficient information to enable the VPC to request the location of a UA.

In step 2, the UA initiates an emergency call to the CS over v1 and includes the LocationKey in a LIE which is sent with the call initiatino message.

In step 3, the CS determines the provisioned callback number and subscriber name associated with the UA, and constructs an esrRequest message that includes a CallID, callback number, subscriber name and LIE containing the LocationKey. The CS sends the esrRequest message to the VPC.

In step 4, the VPC receives the esrRequest from the CS and authenticates the CS. The VPC uses the LIS ID to send the LIE to the LIS, and request a LocationObject over v3.

In step 5, the LIS authenticates and validates the LocationKey, and sends the same to the VPC. The LIS returns a LIE to the VPC containing a valid PIDF-LO.

In step 6, the VPC uses the location returned by the LIS to request routing information from the ERDB (not pictured). The VPC allocates an ESQK. The VPC constructs an esrResponse message containing the ESQK, LRO, and either the ESGWRI or the Selective Routing Identifier, routing ESN, and NPA (the ERT), and returns this to the CS over v2.

In step 7, the CS uses the ESGWRI, if received in the routing response, to determine the correct ESGW, or the CS determines the ESGW and appropriate ESGWRI value based on the Selective Routing Identifier, routing ESN, and NPA received in the routing response message. The CS subsequently routes the call to the ESGW, and includes the ESGWRI, ESQK and callback number in outgoing signaling.

In step 8, the CS detects that the call has concluded, and that the ESQK is no longer required. The CS sends an ESCT message containing the ESQK, ESGW identifier, and Call ID to the VPC.

In step 9, the VPC accepts the ESCT message, authenticates the CS, returns the ESQK to the pool of available keys, and notes the ESGW identifier in the call event records. The VPC sends an ESCTAck message to the CS.

FIG. 5 describes a conventional call flow where an invalid PIDF-LO document is provided by the LIS. In FIG. 5, v2 messages are identified in bold.

In step 1 of FIG. 5, the LIS provides a PIDF-LO containing civic address information to the UA over v0.

In step 2, the UA initiates an emergency call to the CS over v1 and includes the PIDF-LO in the call initiation message.

In step 3, the CS determines the provisioned callback number and subscriber name associated with the UA, and constructs an esrRequest message that includes a Call ID, callback number, subscriber name, and a LIE containing the PIDF-LO. The CS sends the esrRequest message to the VPC over v2.

In step 4, the VPC receives the esrRequest from the CS and authenticates the CS. The VPC is unable to determine routing based on the location so it returns an error indication in the esrResponse to the CS with no LRO.

In step 5, the error indication in the esrResponse message triggers the CS to perform its default routing behavior using local default routing policies (as shown in the example call flow above) which may be to send the call to a default PSAP via an admin line or to a third party call center. When the call is routed to a PSAP admin line or a third party call center, a PSTN gateway will be used instead of an ESGW.

In step 6, some time later, the caller hangs-up, the CS detects that the call has concluded, and forwards the call termination message to the PSTN gateway.

Thus, the NENA Interim VoIP Architecture for Enhanced 9-1-1 Services (i2), NENA 08-001 v2 Specification requires certain result codes to be sent after processing an Emergency Call (E911) Routing query over the v2 Interface. This result code is sent in the v2 ESRResponse message from the VoIP Positioning Center (VPC) to the Call Server/Proxy to indicate the success or failure (and what type of failure) that occurred during processing the v2 request.

But in practice, setting the result code requires storage of information about the original request source, as well as determination of the type of routing that was used during the actual processing of this request. The present inventors have appreciated that storage and eventual retrieval of information about the original request source for any given request, as well as mating that with a type of routing that was used during the processing of that request, requires additional resources and imposes additional data traffic on a provider's network.

### SUMMARY OF THE INVENTION

In accordance with the principles of the present invention, a method of building an ESRResponse header including location and routing information, comprises a first field containing only one unique value indicating a source of location information. A second field indicates only one unique value indicating a source of routing to a responder.

In accordance with more detailed aspects of another embodiment of the invention, possible predefined values of the first field comprise a first possible unique value indicating that no location information was obtained. A second possible unique value indicates that the location was obtained from call signaling. A third possible unique value indicates that the location relates to information from a subscriber obtained from a location information server (LIS). A fourth possible unique value indicates that the location relates to information from a location profile obtained from a location information server (LIS). A fifth possible unique value indicates that the location relates to information from a custom location source.

In accordance with more detailed aspects of yet another embodiment of the invention, possible predefined values of the second field comprise a first possible unique value indicating that the routing to the emergency responder is carrier default routing. A second possible unique value indicates that the routing to the emergency responder was calculated using only address without use of GIS. A third possible unique value indicates that the routing to the emergency responder was calculated using GIS from a given position. A fourth possible unique value indicates that the routing to the emergency responder was calculated using GIS from a geocoded full address. A fifth possible unique value indicating that the routing to the emergency responder was calculated using GIS from only city/state/Zip code. A fixed set of possible unique values of the second field condense information to complete routing of a given emergency call.

### BRIEF DESCRIPTION OF THE DRAWINGS

Features and advantages of the present invention will become apparent to those skilled in the art from the following description with reference to the drawings:

FIG. 1 shows the process utilized by an exemplary result code handler including the method of building an ESRResponse header including a v2 Result code, in accordance with the principles of the present invention.

FIG. 2 depicts a conventional example esrResponse message showing a successful response (result=200).

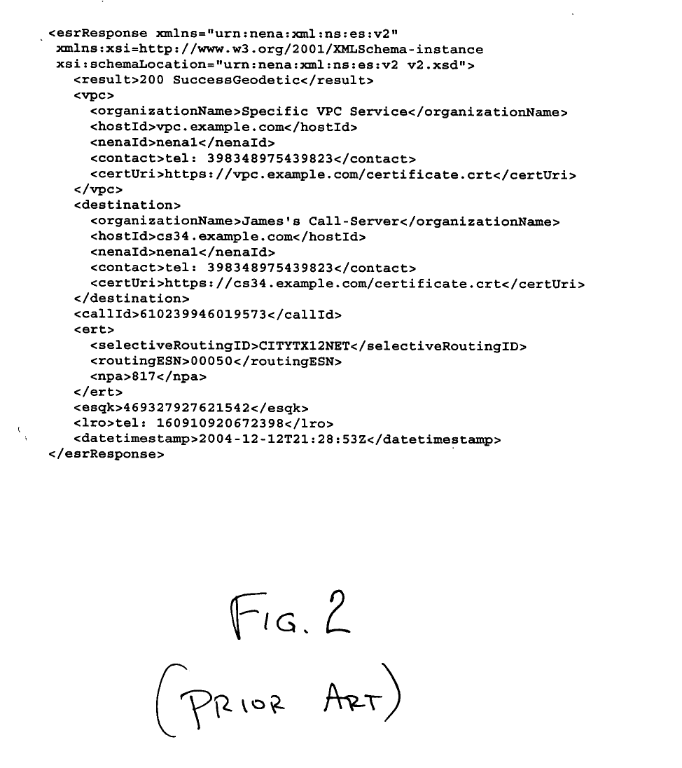

FIG. 3 shows a conventional call flow where a valid PIDF-LO document containing a geodetic and/or civic location is provided by the LIS.

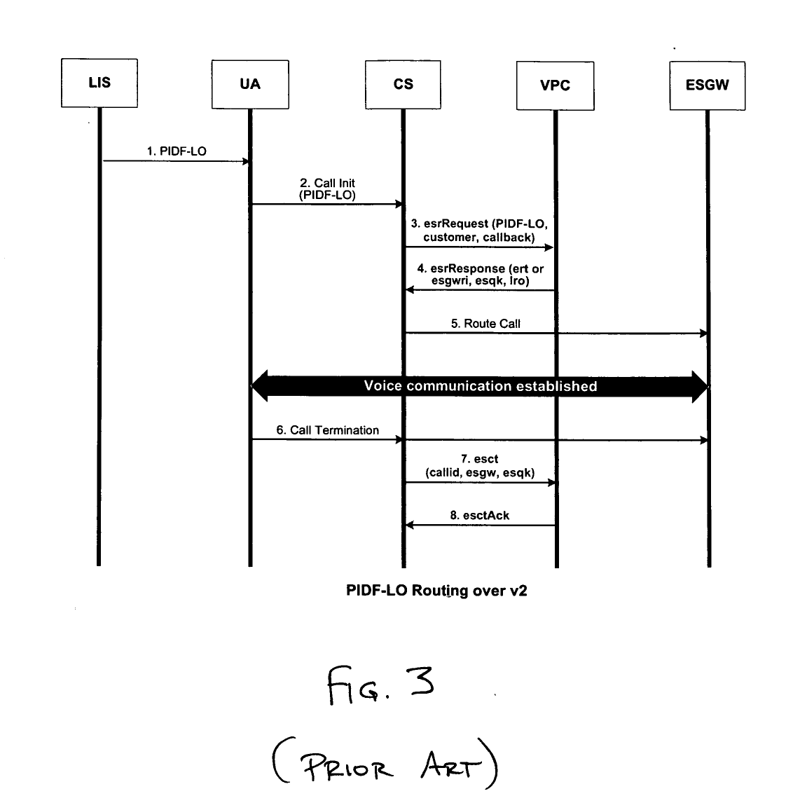

FIG. 4 describes a conventional call flow where a Location Key is provided by the LIS.

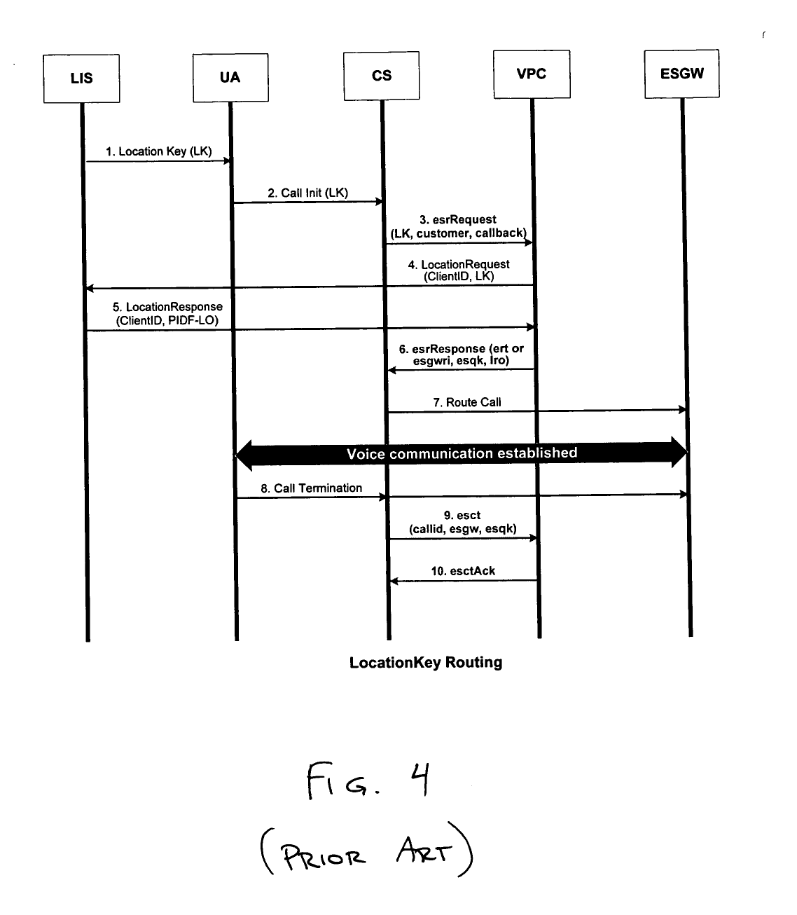

FIG. 5 describes a conventional call flow where an invalid PIDF-LO document is provided by the LIS.

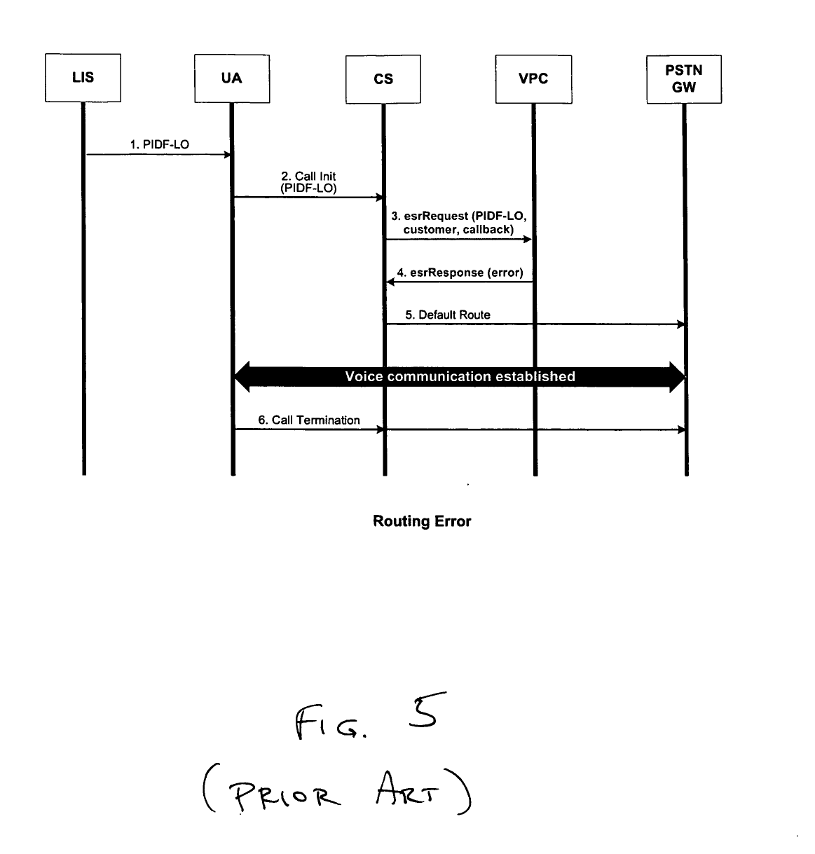

### DETAILED DESCRIPTION OF ILLUSTRATIVE EMBODIMENTS

The present inventors have appreciated that a Voice Over Internet Protocol (VoIP) positioning center (VPC) does not expect a v2 emergency services call termination (ESCT) message at call termination time since no emergency services query key (ESQK) was allocated for that call. The present inventors have also appreciated that setting a v2 Result code is contingent on numerous factors that could occur during the handling of the request. The inventors have further appreciated that there is a need for a simpler, efficient method to condense down all the various factors contributing to the resulting value called a v2 Result Code.

Table 6-3 shows the four NENA imposed successful v2 ERRResponse Result code values 200, 201, 202 and 203. The present invention provides a simplified method of encoding information needed to set the v2 Result code based on two essential factors that are stored in a data store at runtime. This data store is referred to herein as a “Call Data table”.

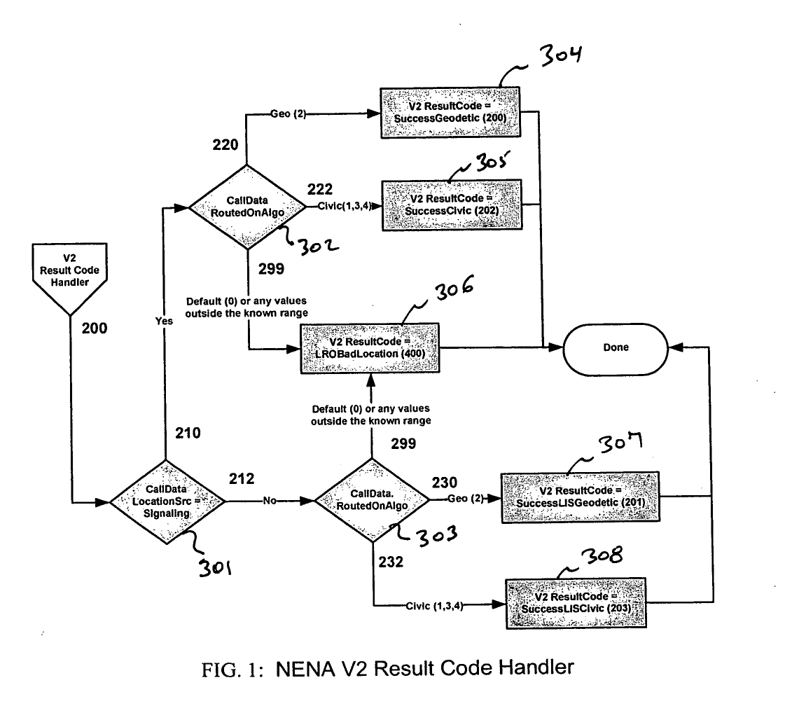

FIG. 1 shows the process utilized by an exemplary result code handler including the method of building an ESRResponse header including a v2 Result code, in accordance with the principles of the present invention.

In particular, as shown in FIG. 1, a v2 result code handler 200 produces two fields created as simple enumerated types: LocationSrc and RoutedOnAlgo. For each emergency call there is one entry in this data store.

LocationSrc is the location source of location information. Possible values (though not limited thereto) of the LocationSrc field are, e.g.:
“0” indicates “No Location,” meaning that neither Address nor Position (i.e. geographical latitude and longitude) in location.
“1” indicates “Signaling” meaning that the location is in the call signaling.
“2” indicates Location was obtained from a standard Location Information Server (LIS), with the Location denoting a “subscriber,” e.g., a real person.
“3” indicates Location was obtained from a standard Location Information Server (LIS), with the Location denoting a “location profile,” e.g., a WiFi hotspot.
“4” indicates Location was obtained from a custom source, e.g., a WiMax source.

RoutedOnAlgo is a call routing method used to determine a route to the responder—the PSAP (Public Safety Answering Point). Possible values (though not limited thereto) of the RoutedOnAlgo field are, e.g.:
0 indicates “Default Routed,” meaning that carrier default routing was used, possibly to a designated Call Center.
1 indicates “Table Routed,” i.e., the route was computed using only address without use of GIS (SDE point-in-poly) (see also TCS U.S. Provisional No. 61/136,255 entitled “A unique nationwide method to table route VoIP Emergency Calls”, co-owned herewith.
2 indicates “Point-in-Poly,” i.e., that the route was computed using GIS (SDE point-in-poly) from a given position (latitude and longitude).
3 indicates “Geocoded Full Address,” i.e., that the route was computed using GIS from geocoded address—full address used.
4 indicates “Geocoded City/State/Zip,” i.e., that the route computed using GIS from geocoded address—only city/state/zip used.

In accordance with the invention, LocationSrc and RoutedOnAlgo each have a fixed set of possible values to condense information needed to complete routing of a given emergency call. A fixed set of possible values is also used to set the proper v2 Result code. Together they hold all that is needed to know how to finish routing a call.

Given the two input sources, there are 25 possible combinations that may contribute to the NENA required Result Codes. In fact, there may even be more input combinations in the case where there are more than five location sources or more than five employed routing paths. This invention provides an ingenious way to quickly and efficiently determine one of the four NENA Result codes given the myriad of possible input combinations.

Referring again to FIG. 1, in step 301, the LocationSrc field in the CallData table has five possible values, one of which is “Signaling.” This indicates the location information originated embedded in the original v2 ESRRequest message (e.g., a smart hand set may have embedded this information into the call signaling at call origination time). If the LocationSrc field is set to “Signaling,” then processing proceeds to step 302. If not, then processing proceeds to step 303.

At either step 302 or step 303, all that is left is to evaluate the path used to route the call (the RoutedOnAlgo field) to complete the mapping to one of the required four NENA V2 Result codes.

In the direction of step 302, at step 304, if the address has been geocoded during call routing 220, then the Result Code is the NENA v2 ‘SuccessGeodetic’ with a value of 200.

In all other instances, moving to step 305, the call has been routed using the civic address—either by table routing or by geocoding the civic address, and the Result Code is set to the NENA ‘SuccessCivic’ with a value of 202.

An unsuccessful location result moves to step 306 before completion of the process.

If the source of the location information was not from Signaling, then as depicted in step 303 it is presumed to have been returned from a location information server (LIS) or a custom source 212. At this point the path that has been used to route the emergency call is evaluated (the RoutedOnAlgo field).

The process moves to step 307, if the geodetic routing causes the result to be the NENA ‘SuccessLISGeodetic,’ with the value of 201.

Any other routing path is presumed to have been based on the civic address, thereby moving to step 308, with a result of NENA ‘SuccessLISCivic,’ with the value of 203.

To be judged ‘Civic’ there are three possible values the RoutedOnAlgo can be set to:
‘1’ indicating Table routed,
‘3’ indicating Geocoded Full Address, and
‘4’ indicating Geocoded City/State/Zip.
   All three, for Result Code purposes, are treated the same in accordance with the principles of the invention.

Just as from step 302, any error scenario such as unknown or default value for the RoutedOnAlgo will result in movement to step 306, with the NENA ‘LROBadLocation’ Result code, and a value of 400, after which the process is done.

The inventive technology provides a concise and ingenious way of encoding the conventional complicated interactions between where the location data originated, and how the route was determined to the proper NENA defined V2 Result code. This Result code serves as an indication to the Call Server of the result of its originating emergency ESRRequest query.

While the invention has been described with reference to the exemplary embodiments thereof, those skilled in the art will be able to make various modifications to the described embodiments of the invention without departing from the true spirit and scope of the invention.

What is claimed is:

1. A method of building an ESRResponse header including location and routing information, comprises:
a first field containing only one unique value indicating a source of location information; and
a second field indicating only one unique value indicating a source of routing to a responder.

2. The method of building an ESRResponse header including location and routing information according to claim 1, wherein:
said response header forms a v2 result code header in conformance with NENA i2 standards for VoIP emergency calls.

3. The method of building an ESRResponse header including location and routing information according to claim 1, wherein:
said first field comprises at least five possible predefined values.

4. The method of building an ESRResponse header including location and routing information according to claim 3, wherein said at least five possible predefined values of said first field comprise:
a first possible unique value indicating that no location information was obtained;
a second possible unique value indicating that said location was obtained from call signaling;
a third possible unique value indicating that said location relates to information from a subscriber obtained from a location information server (LIS);
a fourth possible unique value indicating that said location relates to information from a location profile obtained from a location information server (LIS); and
a fifth possible unique value indicating that said location relates to information from a custom location source.

5. The method of building an ESRResponse header including location and routing information according to claim 1, wherein:
said second field comprises at least five possible predefined values.

6. The method of building an ESRResponse header including location and routing information according to claim 5, wherein said at least five possible predefined values of said second field comprise:
a first possible unique value indicating that said routing to said emergency responder is carrier default routing;
a second possible unique value indicating that said routing to said emergency responder was calculated using only address without use of GIS;
a third possible unique value indicating that said routing to said emergency responder was calculated using GIS from a given position;
a fourth possible unique value indicating that said routing to said emergency responder was calculated using GIS from a geocoded full address; and
a fifth possible unique value indicating that said routing to said emergency responder was calculated using GIS from only city/state/Zip code.
wherein a fixed set of possible unique values of said second field condense information to complete routing of a given emergency call.

7. The method of building an ESRResponse header including location and routing information according to claim 4, wherein possible predefined values of said second field comprise:
a first possible unique value indicating that said routing to said emergency responder is carrier default routing;
a second possible unique value indicating that said routing to said emergency responder was calculated using only address without use of GIS;
a third possible unique value indicating that said routing to said emergency responder was calculated using GIS from a given position;
a fourth possible unique value indicating that said routing to said emergency responder was calculated using GIS from a geocoded full address; and
a fifth possible unique value indicating that said routing to said emergency responder was calculated using GIS from only city/state/Zip code.
wherein a fixed set of possible unique values of said second field condense information to complete routing of a given emergency call.

8. The method of building an ESRResponse header including location and routing information according to claim 1, wherein possible predefined values of said first field comprise:
a first possible unique value indicating that no location information was obtained;
a second possible unique value indicating that said location was obtained from call signaling;
a third possible unique value indicating that said location relates to information from a subscriber obtained from a location information server (LIS);
a fourth possible unique value indicating that said location relates to information from a location profile obtained from a location information server (LIS); and
a fifth possible unique value indicating that said location relates to information from a custom location source.

9. The method of building an ESRResponse header including location and routing information according to claim 8, wherein possible predefined values of said second field comprise:
a first possible unique value indicating that said routing to said emergency responder is carrier default routing;
a second possible unique value indicating that said routing to said emergency responder was calculated using only address without use of GIS;
a third possible unique value indicating that said routing to said emergency responder was calculated using GIS from a given position;
a fourth possible unique value indicating that said routing to said emergency responder was calculated using GIS from a geocoded full address; and
a fifth possible unique value indicating that said routing to said emergency responder was calculated using GIS from only city/state/Zip code.
wherein a fixed set of possible unique values of said second field condense information to complete routing of a given emergency call.

10. The method of building an ESRResponse header including location and routing information according to claim 1, wherein possible predefined values of said second field comprise:
a first possible unique value indicating that said routing to said emergency responder is carrier default routing;
a second possible unique value indicating that said routing to said emergency responder was calculated using only address without use of GIS;
a third possible unique value indicating that said routing to said emergency responder was calculated using GIS from a given position;
a fourth possible unique value indicating that said routing to said emergency responder was calculated using GIS from a geocoded full address; and
a fifth possible unique value indicating that said routing to said emergency responder was calculated using GIS from only city/state/Zip code.
wherein a fixed set of possible unique values of said second field condense information to complete routing of a given emergency call.
